(19) United States
(12) Patent Application Publication
(10) Pub. No.: US 2015/0351138 A1
(43) Pub. Date: Dec. 3, 2015

(54) INTELLIGENT BEARER SETUP CONFIGURATION CONTROL

(71) Applicant: NOKIA SOLUTIONS AND NETWORKS OY, Espoo (FI)

(72) Inventors: Esa Markus METSALA, Espoo (FI); Jari SALO, Helsinki (FI)

(21) Appl. No.: 14/436,574

(22) PCT Filed: Oct. 18, 2012
(86) PCT No.: PCT/EP2012/070610

§ 371 Date: Apr. 17, 2015

(51) Int. Cl. H04W 76/02; H04L 12/46; H04W 28/02; H04L 12/723; H04L 12/24; H04W 72/04

(52) U.S. Cl. CPC H04W 76/021; H04L 41/08; H04W 72/0406; H04W 28/0205; H04L 45/50; H04L 12/4641; H04W 28/0268

(57) ABSTRACT

There are provided measures for intelligent bearer setup configuration control. Such measures exemplarily comprise detection of at least one setup requirement for setup of a bearer, and selection of a termination point for a bearer between a first network element and a second network element among a plurality of available candidate termination points on the basis of the detected at least one setup requirement. For example in a LTE/LTE-A system environment, the setup configuration of a S1 bearer between eNB and SGW can be controlled on the basis of setup requirements for an E-RAB.

### FIELD

The present invention relates to an intelligent bearer setup configuration control. More specifically, the present invention exemplarily relates to measures (including methods, apparatuses and computer program products) for realizing an intelligent bearer setup configuration control.

### BACKGROUND

The present specification generally relates to the setup of bearers and the control of a configuration of a bearer setup. Accordingly, while specific reference is made hereinafter to a 3GPP, especially a LTE/LTE-A, system environment (such as illustrated in FIG. 1), such reference is made for explanatory purposes by way of example only. The principles described herein are generally applicable for any kind of bearer and any kind of bearer setup irrespective of the underlying system environment, including for example a 3G (e.g. HSPA) system environment.

Generally, for the purpose of the present specification, a bearer is intended to refer to a transport bearer relating to connectivity service, e.g. an IP-based connectivity service, between two termination points, which then provide the service for the higher layer protocols. In this regard, terms like “endpoint” or “termination point” may be used. Here, the term “termination point” is used in view of current 3GPP terminology relating to LTE/LTE-A as well as 3G, while the term “termination point” as used herein is to be understood to be equivalent to the term “endpoint” or any equivalent term. A termination point may be defined by an IP address (Transport Layer Address in 3GPP terms) and, possibly also, a L4-port such as an UDP/SCTP/TCP port, and/or further possibly for example GTP(-U) TEIDs. In a 3GPP system environment, a transport bearer provides the needed transport service for higher layers. It is to be noted that a L4-port may be specified by standard and does not need to be signaled (such as e.g. in the case of LTE S1 and X2 signaling in 3GPP specifications), or may be signaled (such as e.g. in 3G specifications). Conventionally, a bearer such as a transport bearer is set up by using a single, same termination point available for every type of bearer at each end element of the bearer, i.e. with a fixed bearer setup configuration. In the exemplary case of setup of a S1 bearer in a LTE/LTE-A system environment, i.e. a user plane bearer on the S1 interface between eNB and SGW, such S1 bearer is set up using a single termination point at the eNB and a single termination point at the SGW, where the same termination points are used for all types of bearers.

With the use of a single termination point at each end element of a user plane bearer for all kind of traffic, all bearer traffic is terminated into the same IP address (and/or the like, as described above). While typically the user plane has its own address, the control plane has its own address and the management plane has its own address, all traffic types could in general be terminated into a single IP address at a destination side of a bearer in question. Accordingly, a problem with having a single IP address in the user plane as a bearer termination point is that destination based routing routes the packets based on the destination address. When the destination address is identical due to use of a single IP address as the IP layer bearer termination point information, packets typically all follow the same transmission path or route e.g. in the backhaul network, even though there are use cases where different transmission paths or routes should preferably be taken.

In order to establish (quality-related) properties of the bearer to be set up, setup requirements e.g. in the form of signaling parameters are conventionally used. In the exemplary case of setup of a S1 bearer, the QCI carried by S1 (eNB-MME) and S11 (SGW-MME) signaling is used to establish dedicated bearers.

Accordingly, different quality (QoS) levels can be supported based on the QCI in the form of different EPS bearers including different S1 bearers. These different bearers can receive a differentiated treatment in that the QCI defining the different quality (QoS) levels is typically encoded into the DSCP field of the IP packet to be transmitted. This means that different EPS bearers with a different QCI can have different DSCP encodings, and, if they need different transmission paths or routes in the backhaul network, the DSCP field can additionally be used for routing purposes. Such routing approach based on quality-related DSCP encodings does however not allow differentiation of the transmission path or route in the backhaul network based on any criteria or parameter other than DSCP. Moreover, routing based on DSCP encodings is more complex than conventional routing based on the IP destination address.

For routing with more than a hop-by-hop control of the transmission paths or routes in the backhaul network, either policy based routing or MPLS traffic engineering is typically used. With policy based routing, DSCP encodings may for example be utilized. This requires a special configuration at each of the routers or other backhaul network elements on the path to the destination, and leads to a complex network design.

With MPLS traffic engineering and MPLS in general, a forwarding equivalence class (FEC) defines a mapping of traffic to the MPLS label switch paths. While the definition of a FEC is critical as such, the FEC, at simplest, is based on a destination address. With MPLS traffic engineering, a path is then computed through the network, and labels assigned, allowing traffic engineering applications.

Both of these approaches, policy based routing and MPLS applications (like traffic engineering), suffer from the need for additional special functionality in all involved elements, i.e. DSCP-based routing or the use of MPLS.

For the addressing, as outlined above, a single termination point is conventionally used for the user plane e.g. of the eNB, i.e. user plane bearers, at the end elements thereof (e.g. eNB and SGW in the case of a S1 bearer), while the use of two termination points for different operators (a single operator having a fixed termination point) is considered in the case of a multi-operator radio network (i.e. network sharing), and the EPS bearers including the S1 bearers are differentiated by QCIs and DSCPs.

For differentiation, that is to say, the EPS bearers including the S1 bearers are differentiated based on QCI (thus using dedicated bearers based on QCI), and a mapping to DSCPs provides the information of the bearer to the IP and other transport layers.

This is however not adequate or sufficient for many use cases, as the reasons for different behaviors or the need for different transmission paths or routes e.g. in the backhaul network are not all QoS related, and not all necessary information for such use cases is encoded to be available in the DSCPs.

As an example use case which could not be adequately handled by the above-outlined QoS related routing approaches, part of the user plane traffic or bearers may be wished to be transmitted within an IPsec tunnel, while other user plane traffic or bearers should be transmitted via a default IP path (without IPsec protection). As another example use case which could not be adequately handled by the above-outlined QoS related routing approaches, GBR traffic or bearers (e.g. of certain subscriber classes) may be wished to use a transmission path or route separate from that of non-GBR traffic or bearers (e.g. of other subscriber classes).

In addition to the complexity introduced by QoS policy based routing, a further complication is that encoding this information to the DSCPs is not straightforward. This is because the QoS treatment wished for the traffic may in fact be the same, so same DSCP should be used, but it is only wished to use a separate transmission path. An example is the IPsec protection: background traffic for business users may be wished to be carried over a IPsec protected path, while background traffic for residential customers would use a path without IPsec protection. The traffic in both cases is assumed to be best effort and would use DSCP value of ‘0’ in the standard case. While using another value may be feasible, this adds complexity, as the QoS encoding in the DSCP field would need a unique interpretation, meaning that in one case background traffic uses DSCP ‘0’ and in another case background traffic would use a different value. In a large network with multiple traffic types, implementing these special rules is a disadvantage or even a blocking factor for the applicability of QoS policy based routing as a solution to the aforementioned drawback/problem.

In case of MPLS, definition of a FEC to match on DSCPs is more complex than a destination address based definition. However, a real limitation is that, as the MPLS Label Switched Path (LSP) typically does not start directly from a mobile network element (e.g. eNB or SGW), the MPLS network element (NE) needs to have the FEC specification. Here, a difficulty arises because the MPLS NE does not have the same amount of information than the mobile NE has. An example is e.g. the ARP parameter, which is carried by the S1-AP signaling. Even if the MPLS NE is integrated to the mobile network element, supporting mapping from 3GPP specific parameters to the MPLS FEC would bring an additional effort. In a more common case, the MPLS NE is a separate external equipment, in which case such mapping support is not even possible, since e.g. the ARP parameter (in addition to other parameters carried by S1 and S11 signaling), is only available in the mobile NE and not in the MPLS NE.

Moreover, the need or desire for separate transmission paths or routes could be in general due to functionalities and characteristics of the different transmission paths or routes, and the different transmission paths or routes may have very different characteristics, which are not necessarily QoS related. In this regard, an IPsec protected path was given as an example above. Another example could for example be availability. A certain path may enjoy a higher availability, e.g. due to configuration of redundant links and nodes in the backhaul network, and it may be wished that some types of bearers are routed via this path based on different destination addresses.

In general, the differences in the paths need not be of technical nature in the sense that certain technical characteristics differ, but they may as well relate to costs, types of access lines, administration and ownership of the transmission links, other traffic types already existing in that specific path, etc. Any of these differences may be used as a characteristic to implement a separate termination point in the mobile network element, which then allows directing specific traffic to/from that termination point via the specific separate path.

Accordingly, it is desirable to enable an intelligent bearer setup configuration control capable of complying with various considerations for the routing of bearer traffic via separate transmission paths or routes.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising detecting at least one setup requirement for setup of a bearer, and selecting, among a plurality of available candidate termination points, a termination point for a bearer between a first network element and a second network element on the basis of the detected at least one setup requirement.

According to an exemplary aspect of the present invention, there is provided an apparatus comprising an interface configured to connect to at least another apparatus, a memory configured to store computer program code, and a processor configured to cause the apparatus to perform: detecting at least one setup requirement for setup of a bearer, and selecting, among a plurality of available candidate termination points, a termination point for a bearer between a first network element and a second network element on the basis of the detected at least one setup requirement.

According to an exemplary aspect of the present invention, there is provided a computer program product comprising computer-executable computer program code which, when the program is run on a computer (e.g. a computer of an apparatus according to the aforementioned apparatus-related exemplary aspect of the present invention), is configured to cause the computer to carry out the method according to the aforementioned method-related exemplary aspect of the present invention.

The computer program product may comprise or may be embodied as a (tangible) computer-readable (storage) medium or the like on which the computer-executable computer program code is stored, and/or the program is directly loadable into an internal memory of the computer or a processor thereof.

Advantageous further developments or modifications of the aforementioned exemplary aspects of the present invention are set out in the following.

By way of exemplary embodiments of the present invention, there may be enabled an intelligent bearer setup configuration control capable of complying with various considerations for the routing of bearer traffic via separate transmission paths or routes. Such intelligent bearer setup configuration control may be based on using differentiated source and destination addresses in termination point definition.

Thus, improvement is achieved by methods, apparatuses and computer program products enabling/realizing an intelligent bearer setup configuration control.

### BRIEF DESCRIPTION OF THE DRAWINGS

In the following, the present invention will be described in greater detail by way of non-limiting examples with reference to the accompanying drawings, in which

FIG. 1 shows a schematic block diagram of a system environment, in which exemplary embodiments of the present invention are applicable,

FIG. 2 shows a schematic block diagram of a system environment according to exemplary embodiments of the present invention,

FIG. 3 shows a flowchart of a first example of a procedure according to exemplary embodiments of the present invention,

FIG. 4 shows a flowchart of a second example of a procedure according to exemplary embodiments of the present invention,

FIG. 5 shows a flowchart of a third example of a procedure according to exemplary embodiments of the present invention, and

FIG. 6 shows a schematic diagram of apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments, such as e.g. LTE/LTE-A system environments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein. This exemplarily but not exclusively includes 3G (e.g. HSPA) systems.

In particular, the present invention and its embodiments may be applicable in any communication system and/or network deployment in which bearers are used for traffic transportation and, thus, some bearer setup configuration control is (to be) realized.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) an intelligent bearer setup configuration.

In the following, without restriction to the general applicability of exemplary embodiments of the present invention, it is exemplarily assumed for illustrative purposes only that a radio access network element, e.g. an eNB, represents a first network element (a first user plane element), while a core network element, e.g. a SGW, represents a second network element (a second user plane element), wherein a bearer is to be set up between the first and second network elements, and where the necessary signaling that controls the bearer set-up is supported by a separate control plane element (MME), with an interface from the separate control plane element (MME) to the first network element and another interface from the separate control plane element (MME) to the second network element. As is to be understood, exemplary embodiments of the present invention are equally applicable when both the first and second network elements are represented by a radio access network element, or when both the first and second network elements are represented by a core network element, or the like. Further, exemplary embodiments of the present invention are equally applicable when control plane signaling is implemented e.g. directly between the first and second network elements that support the termination points (i.e. without involvement of a separate control plane element), or when a separate control plane element interfaces both user plane elements via the same interface.

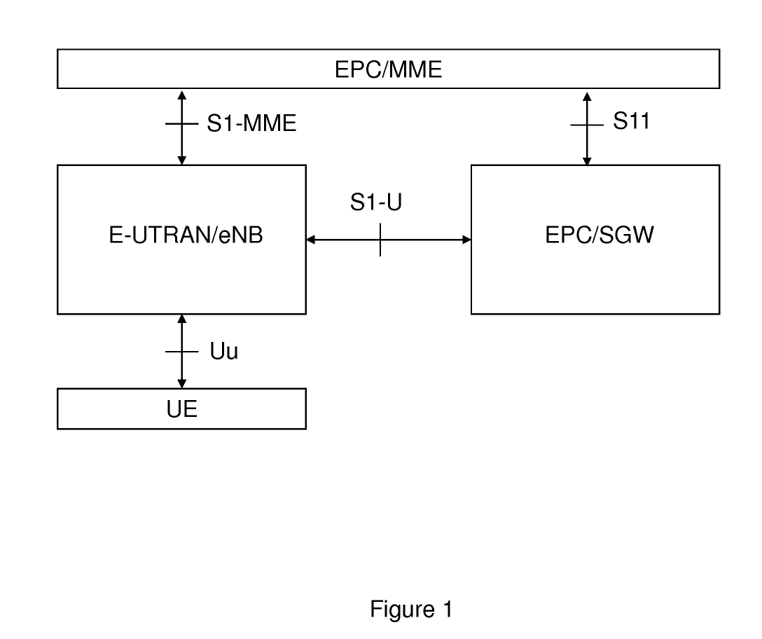

FIG. 1 shows a schematic block diagram of a system environment, in which exemplary embodiments of the present invention are applicable.

In the exemplary LTE/LTE-A based system environment according to FIG. 1, a user equipment UE is connected with a radio access network part via a Uu interface, wherein the radio access network part which could be constituted by at least one of an E-UTRAN representing a radio access network and an eNB representing a radio access network element in the user plane. Further, the radio access network part is connected with a core network part via a S1-U (user plane) interface, wherein the core network part could be constituted by at least one of an EPC (Evolved Packet Core) representing a core network and a SGW representing a core network element in the user plane. Still further, the radio access network part is in the control plane connected with a mobility management part via a S1-MME (management/control plane) interface, and the core network part is in the control plane connected with the mobility management part via a S11 (management/control plane) interface, wherein the mobility management part could be constituted by an MME representing a mobility management entity in the core network domain. In the illustrated example, the (core network) control plane element (i.e. MME) is thus exchanging signaling messages with both the radio access network user plane (E-UTRAN/eNB) and the core network user plane (EPC/SGW).

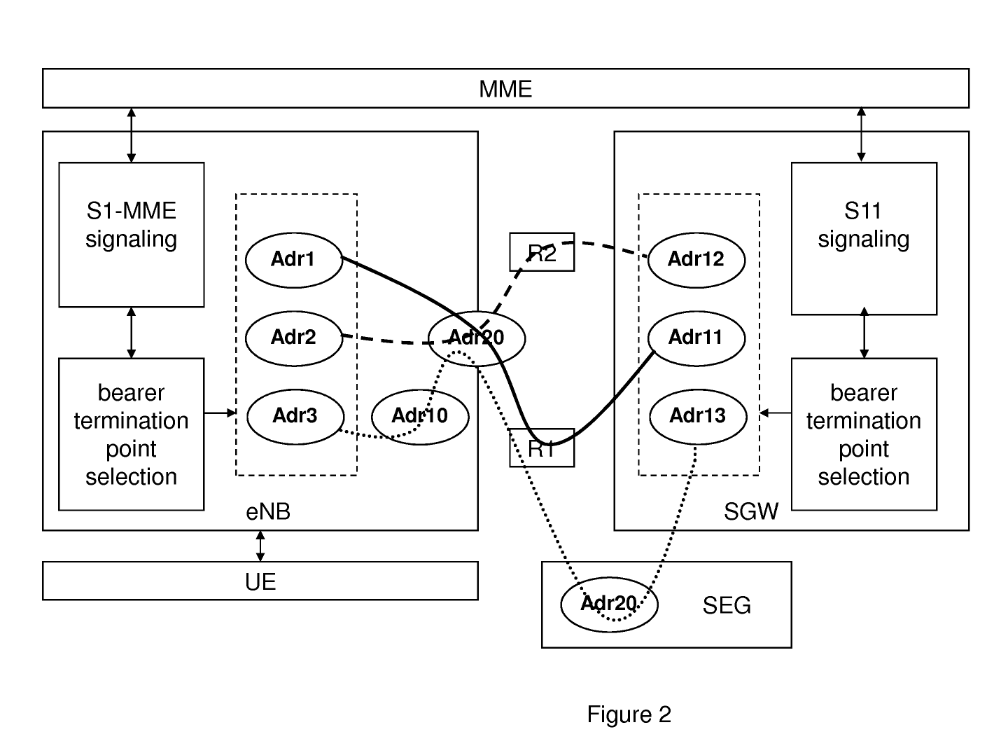

FIG. 2 shows a schematic block diagram of a system environment according to exemplary embodiments of the present invention. The system environment according to FIG. 2 is based on the LTE/LTE-A based system environment according to FIG. 1.

In the exemplary system environment according to FIG. 2, it is assumed that the eNB comprises a S1-MME signaling function (with a connection to the MME), a bearer termination point selection function and a plurality of available candidate termination points (i.e. Adr1, Adr2 and Adr3 at the eNB). Similarly, it is assumed that the SGW comprises a S11 signaling function (with a connection to the MME), a bearer termination point selection function, and a plurality of available candidate termination points (i.e. Adr11, Adr12 and Adr13 at the SGW). It is noted that exemplary embodiments of the present invention are not limited to such example system environment, but also encompass system environments in which only one of the eNB and the SGW comprises the aforementioned functions and plurality of candidate termination points. Also, the number of candidate termination points at any one of eNB and SGW are not limited to three but could be any arbitrary integer number, and the number of candidate termination points at eNB and SGW are not necessarily the same.

In the exemplary system environment according to FIG. 2, it is assumed that the eNB has a single physical port denoted by Adr20 and the available candidate termination points at the eNB represent loopback (application) IP addresses, L4 ports and/or GTP-TEIDs, and that the SGW has multiple physical ports (not illustrated) and the available candidate termination points at the SGW represent physical or loopback (application) IP addresses, L4 ports and/or GTP-TEIDs. It is noted that exemplary embodiments of the present invention are not limited to such example system environment, but also encompass system environments in which the eNB comprises a single physical port and the SGW comprises multiple physical ports or in which both eNB and SGW comprise a single physical port or multiple physical ports.

In the exemplary system environment according to FIG. 2, it is assumed that there are present three transmission paths between eNB and SGW, one via each of routers R1 and R2, wherein one path thereof comprises an IPsec protected path between IPsec tunnel endpoints at Adr10 at the eNB and Adr20 at a SEG (Security Gateway) being connected to the SGW. The IPsec protected path in this example thus assumes that the IPsec protocol is implemented within the eNB, and that the IPsec tunnel endpoint is within the eNB. However, this need not generally be the case, but an IPsec protected path could as well be supported by another SEG located at the eNB site, for example. It is noted that exemplary embodiments of the present invention are not limited to such example system environment, but also encompass system environments in which a different number of transmission paths or routes are available, wherein none or a different number thereof represent IPsec tunnel paths between IPsec tunnel endpoints which are not necessarily located at the eNB and the SEG but could for example also be located not (directly) at the eNB and/or (directly) at the SGW.

According to exemplary embodiments of the present invention, the S1-MME signaling function at the eNB is configured to receive a signaling message or at least signaling parameters from the MME via the S1-MME interface. The S11 signaling function at the SGW is configured to receive a signaling message or at least signaling parameters from the MME via the S11 interface. Any one of the S1-MME and/or S11 signaling functions at the eNB and the SGW is configured to detect at least one setup requirement for setup of a bearer, i.e. a S1 (user plane) bearer in the present example. As depicted in the examples of FIGS. 1 and 2, set up of a S1 bearer occurs with the MME, SGW and eNB, the MME acting as a control plane element with a S1-MME interface towards the eNB and a S11 interface towards the SGW, so that information of the termination points in the eNB and SGW are exchanged with the help of the MME. As mentioned above, the present invention is however not limited to the use of a separate control plane entity (such as the MME of the present example), but is applicable as well to systems where signaling is supported directly between the network elements that terminate the user plane bearers, which is the case e.g. in the 3G Iub interface.

According to exemplary embodiments of the present invention, the bearer termination point selection function at the eNB is configured to select, among the available candidate termination points at the eNB, a termination point for a bearer, i.e. a S1 (user plane) bearer in the present example, to be set up between the eNB and the SGW on the basis of the at least one setup requirement detected by the S1-MME signaling function at the eNB. The bearer termination point selection function at the SGW is configured to select, among the available candidate termination points at the SGW, a termination point for a bearer, i.e. a S1 (user plane) bearer in the present example, to be set up between the eNB and the SGW on the basis of the at least one setup requirement detected by the S11 signaling function at the SGW. The bearer termination point selection function at any one of the eNB and the SGW could be based on a configuration or mapping table, an algorithm or function, or any other means or measure associating bearer setup requirements with different bearer termination points out of the (locally) available termination points, respectively. The bearer set up requirements may be obtained via the S1-MME and/or S11 signaling message parameters, as exemplified in the system environment according to FIGS. 1 and 2, but in general other signaling messages from other sources and/or via other interfaces could equally be utilized.

Generally, candidate termination points at the eNB and/or the SGW may be any kind of addresses (e.g. IP addresses, L4 ports and/or GTP-TEIDs), they may be tied to physical addresses and/or ports or be loopback (application) IP addresses, or they may be sub-interfaces such as VLAN interfaces, or the like. The physical port may be any kind of physical layer port that supports IP transport As non-limiting examples, it may be any type of Ethernet port, with or without VLAN configuration, multiple Ethernet ports with Ethernet Link aggregation, E1, T1, JT1 or other time-division-multiplexed (TDM) port, SDH/Sonet port or yet other physical ports capable of transmitting IP packets, either natively or by means of an encapsulation protocol, such as PPP or GFP or variants of thereof. The IP address may be an IPv4 address or an IPv6 address. The termination point definition may, in addition to the IP layer address, include L4 port (such as UDP port) information and/or GTP TEID (Tunnel Endpoint Identifiers) information, or the like.

For the case of a 3GPP (e.g. LTE/LTE-A) system environment, a transport layer address definition may be utilized, constituting IPv4 or IPv6 addresses. In LTE/LTE-A, the termination point, in addition to the transport layer address (IPv4 or IPv6 address), may use L4 port and/or GTP TEIDs.

For the case of a 3G (e.g. HSPA) system, similarly, an IPv4 or IPv6 address is utilized, and additionally a L4 UDP port (Iub interface, Iur interface, Iu-cs interface) or L4 port and/or GTP TEID (Iu-ps interface) may be used.

In case of LTE and a S1 bearer, a non-limiting example of the transport layer address can be found e.g. in 3GPP TS 36.414, where a further reference is given to IETF RFC 791 (IPv4 address) and IETF RFC 2460 (IPv6 address). 3GPP TS 36.414 and TS 29.281 as well define the UDP port number usage so that the destination UDP port is 2152, while the source port is allocated by the sending entity. In the LTE S1 interface, the key information elements carried by the S1AP signalling between the eNodeB and the MME for the termination point are defined in 3GPP TS 36.413, and are a transport layer address and/or a GTP-TEID.

It is to be noted the above was given as an example of the termination point information carried by 3GPP signaling, concerning the S1 interface. For the purpose of this invention, comparable definitions of termination point information that is carried by another signaling can be found from other 3GPP specifications. For example, in LTE S11 signaling (GTP-C protocol), and for 3G in 3GPP specifications for the Iub interface (NBAP), Iu interface (RANAP, both Iu-cs and Iu-ps) and Iur interface (RNSAP), with some difference in the amount of information carried, and in the detailed specification of the information elements. As an example, in the Iub interface, there is no GTP-U protocol standardized, and thus the termination point is defined by a transport layer address and a UDP port.

As a non-limiting example of the signaling message, upon which the one or more bearer setup requirements are detected, an S1AP INITIAL CONTEXT SETUP REQUEST could be utilized, but generally any signaling message, such as setup and/or request messages, containing bearer setup related parameters is applicable. Referring to the example of FIGS. 1 and 2, any such signaling message sent from the MME to the eNB via the S1-MME interface and/or from the MME to the SGW via the S11 interface is applicable.

In an S1AP INITIAL CONTEXT SETUP REQUEST, which is dedicated for requesting setup of an UE context, any parameters relating to a bearer setup may be utilized, such for example information elements of an item for the setup of an E-RAB (e.g. an E-RAB to be Setup Item). Such information elements may for example comprise usable parameters such as QoS parameters for an E-RAB level (e.g. E-RAB Level QoS Parameters) defining the QoS to be applied to an E-RAB to be set up, or subscriber's HLR profile related parameters, or any other parameter usable in this regard. Examples of QoS parameters include QCI, an ARP, and GBR QoS information (wherein the latter is applicable to GBR bearers). Examples of subscriber HLR profile related parameters include “Closed Subscriber Group (CSG) identity” and “Subscriber Profile ID for RAT/Frequency priority”.

Generally, any kind of signaling parameter or any combination of such signaling parameters may be utilized according to exemplary embodiments of the present invention.

Each EPS bearer/E-RAB (GBR and Non-GBR) may be associated with one or more of the following bearer level QoS parameters:
QoS Class Identifier (QCI): scalar that is used as a reference to access node-specific parameters that control bearer level packet forwarding treatment (e.g. scheduling weights, admission thresholds, queue management thresholds, link layer protocol configuration, etc.), and that have been pre-configured by the operator owning the eNodeB, wherein a specified one-to-one mapping of standardized QCI values to standardized characteristics may be employed.
Allocation and Retention Priority (ARP): the primary purpose of ARP is to decide whether a bearer establishment/modification request can be accepted or needs to be rejected in case of resource limitations; in addition, the ARP can be used by the eNodeB to decide which bearer(s) to drop during exceptional resource limitations (e.g. at handover).

Each GBR bearer may additionally be associated with one or more of the following bearer level QoS parameters:
Guaranteed Bit Rate (GBR): the bit rate that can be expected to be provided by a GBR bearer.
Maximum Bit Rate (MBR): the maximum bit rate that can be expected to be provided by a GBR bearer. MBR can be greater or equal to the GBR.

Each APN access, by a UE, may be associated with the following QoS parameter:
per APN Aggregate Maximum Bit Rate (APN-AMBR).

Each UE in a specified state may be associated with the following bearer aggregate level QoS parameter:
per UE Aggregate Maximum Bit Rate (UE-AMBR).

It is to be noted that GBR and MBR denotes a bit rate of traffic per bearer while UE-AMBR/APN-AMBR denotes a bit rate of traffic per group of bearers. Each of those QoS parameters has an uplink and a downlink component.

While the above-mentioned examples focus on QoS parameters, in general, any kind of information element in any kind of signaling message and/or parameter may be used to realize exemplary embodiments of the present invention. In particular, subscriber profile parameters signaled to a radio access network element could represent an example of such non-QoS parameters, and any other parameter usable in this regard could equally be utilized accordingly.

In LTE/LTE-A, S1AP/X2AP signaling messages containing information elements pertinent to an eNB termination endpoint selection function, which are applicable for exemplary embodiments of the present invention, include, but are not limited to, S1AP E-RAB SETUP REQUEST, S1AP INITIAL CONTEXT SETUP REQUEST, S1AP HANDOVER REQUEST, S1AP PATH SWITCH REQUEST ACKNOWLEDGE, X2AP HANDOVER REQUEST. For details thereof, reference is made to 3GPP TS 36.423 V9.6.0 (2011-03) and 3GPP TS 36.413 V9.8.0 (2011-12). Relevant information elements, which are applicable for exemplary embodiments of the present invention, within the aforementioned S1AP/X2AP messages include, but are not limited to, “UE Aggregate Maximum Bit Rate Downlink”, “UE Aggregate Maximum Bit Rate Uplink”, “QCI”, “E-RAB Maximum Bit Rate Downlink”, “E-RAB Maximum Bit Rate Uplink”, “E-RAB Guaranteed Bit Rate Downlink”, “E-RAB Guaranteed Bit Rate Uplink”, “Subscriber Profile ID for RAT/Frequency Priority”, “CSG Id”, “CSG Membership Status”, “SRVCC Operation Possible”, “Allocation/Retention Priority (Priority Level)”, “Allocation/Retention Priority (Pre-emption Capability)”, “Allocation/Retention Priority (Pre-emption Vulnerability)”. In the case of LTE/LTE-A, the selected eNB transport layer address (IPv4 or IPv6 address), which is a special exemplary instance of the general concept of a bearer termination point, is embedded in a response message to the MME, for example, S1AP INITIAL CONTEXT SETUP RESPONSE.

At the SGW, as an example, Evolved Packet System (EPS) S11 signaling message S11 Create Session Request may be used to create a default EPS bearer according to exemplary embodiments of the present invention. In this regard, relevant information elements, which are applicable for exemplary embodiments of the present invention, include, but are not limited to, “User Location Information”, “Access Point Name (APN)”, “PDN Type”, “Aggregate Maximum Bit Rate”, “UE Time Zone”, “Charging Characteristics”, “Flow Quality of Service”. For details thereof, reference is made to 3GPP TS 29.274 V9.10.0 (2012-03).

The S11 signaling message “S11 Create Session Response” includes the S1 user plane termination point information from the SGW to the MME. The information element is included within the Information Element Bearer contexts created, which further includes S1-U SGW F-TEID, where F-TEID stands for Fully Qualified Tunnel Endpoint Identifier. The definition for F-TEID includes then IPv4 and/or IPv6 address and TEID.

As another example, in case of a UE triggered request for a dedicated bearer, a S11 Bearer Resource Command (which the SGW receives from the MME) contains information elements pertinent to SGW termination endpoint selection function, which are applicable for exemplary embodiments of the present invention.

In addition, Gx (PCRF-PCEF) interface signaling, or PGW built-in policy rules, that may be based on deep packet inspection techniques, may be used in SGW termination endpoint selection according to exemplary embodiments of the present invention.

For example, in a 3G/HSPA system, NBAP/RNSAP signaling messages containing information elements pertinent to NodeB termination endpoint selection, which are applicable for exemplary embodiments of the present invention, include, but are not limited to, NBAP/RNSAP RADIO LINK SETUP REQUEST, NBAP/RNSAP RADIO LINK ADDITION REQUEST, NBAP RADIO LINK RECONFIGURATION PREPARE, RNSAP RADIO LINK RECONFIGURATION REQUEST. Relevant information elements within these NBAP messages, which are applicable for exemplary embodiments of the present invention, include, but are not limited to, “RNC ID”, “Extended RNC ID”, “UE Aggregate Maximum Bit Rate”, “MAC-hs Guaranteed Bit Rate”, “TNL QOS”, “E-DCH Maximum Bitrate”, “MAC-es Guaranteed Bit Rate”, “Scheduling Priority Indicator”. For details thereof, reference is made to 3GPP TS 25.423 V9.9.0 (2012-03) and 3GPP TS 25.433 V9.8.0 (2011-12).

Again, further definition of signaling messages and information elements related to exemplary embodiments of the present invention e.g. for the Iu interface, can be found in other 3GPP specifications for RANAP signaling (Iu interface), or the like.

In the exemplary system environment according to FIG. 2, an example with static routes is illustrated, in which the aforementioned signaling message and signaling parameters are exemplarily utilized.

When receiving GBR QoS information in the S1-MME signaling by the S1-MME signaling function, it is exemplarily assumed that the eNB logic, i.e. the bearer termination point section function at the eNB, selects termination point (IP address, UDP port (source port) and/or GTP TEID) Adr1, and the SGW logic, i.e. the bearer termination point section function at the SGW, selects termination point (IP address, UDP port (source port) and/or GTP TEID) Adr11 for the corresponding traffic. Information of the termination point selected by the eNB may be transmitted by signaling via the MME to the SGW, for the SGW to use. Information of the termination point selected by the SGW may be transmitted by signaling via the MME to the eNB, for the eNB to use.

Accordingly, a first route illustrated by a solid line is established in the context of bearer setup for the bearer traffic subject to such setup requirements according to the received GBR QoS information. In the UL, the next hop from the eNB is R1. In the DL, the next hop from the SGW is R1, assuming symmetrical routing. Correspondingly, the traffic can be routed over a route via router R1. For simplicity, symmetrical routing was assumed, however the use of different paths in UL and DL directions may be equally used as well.

Similarly, when receiving an ARP parameter in the S1-MME signaling by the S1-MME signaling function, it is exemplarily assumed that the eNB logic, i.e. the bearer termination point section function at the eNB, selects termination point (IP address, UDP port (source port) and/or GTP TEID) Adr3, and the SGW logic, when receiving an ARP parameter in the S11 signaling by the S11 signaling function, the bearer termination point section function at the SGW, selects termination point (IP address, UDP port (source port) and/or GTP TEID) Adr13 for the corresponding traffic. Again, information of the selected termination points may be exchanged by signaling via the MME, separately by S1-MME (S1AP) signaling between the eNB and the MME, and by S11 (GTP-C) signaling between the MME and the SGW.

Accordingly, a second route illustrated by a dotted line is established in the context of bearer setup for the bearer traffic subject to such setup requirements according to the received ARP parameter. By interpreting the ARP parameter, related bearer traffic is routed via an IPsec tunnel between the tunnel endpoints being Adr10 in the eNB and Adr20 in the SEG over a route via router R1.

For all other traffic, i.e. all traffic having different setup requirements than those mentioned above, it is exemplarily assumed that the eNB logic, i.e. the bearer termination point section function at the eNB, selects termination point (IP address, UDP port (source port) and/or GTP TEID) Adr2, and the SGW logic, i.e. the bearer termination point section function at the SGW, selects termination point (IP address, UDP port (source port) and/or GTP TEID) Adr12 for the corresponding traffic. Again, information of the selected termination points may be exchanged by signaling via the MME, separately by S1-MME (S1AP) signaling between the eNB and the MME, and by S11 (GTP-C) signaling between the MME and the SGW.

Accordingly, a third route illustrated by a dashed line is established in the context of bearer setup for the bearer traffic subject to such different setup requirements e.g. according to any other signaling parameter. In the UL, the next hop from the eNB is R2. In the DL, the next hop from the SGW is R2. Correspondingly, the traffic can be routed over a route via router R2.

As evident from the above, both the eNB and the SGW can independently select the most suitable termination point (IP address, UDP port (source port) and/or GTP TEID) for any bearer to be set up and, thus, the transmission path or route for the traffic on such bearer based on corresponding bearer setup requirements, e.g. by use of a configuration or mapping table, an algorithm or function, or any other means or measure associating bearer setup requirements with different bearer termination points out of the (locally) available candidate termination points, respectively. The transmission paths or routes through the (backhaul) network may thus be different based on the different source and/or destination addresses (at the SGW for UL traffic or at the eNB for DL traffic). It is also possible that for one direction (DL or UL) the path is different only partially, so that some nodes and/or hops are used commonly for all traffic types, but other nodes and/or hops are different, depending on the route information used. As mentioned above, it is as well possible that paths are different only in one direction (UL or DL).

Accordingly, different EPS bearers including S1 bearers may use different termination points any one of its end elements, i.e. the eNB and/or the SGW, and correspondingly may use different transmission paths or routes in the backhaul network. The use of different termination points may lead to the use of different source/destination IP addresses and/or transport layer addresses (and/or ports), which simplifies the design of the backhaul network and allows more options for traffic separation and/or differentiation and/or selection (i.e. not only QoS based routing). This is generally applicable for all cases in which a need or desire exists for separate network paths or routes, like e. g. an IPsec protected path, a non-IPsec protected path, a GBR guaranteed path, a high availability path, a low cost path, and so on.

According to exemplary embodiments of the present invention, the control plane signaling function (i.e. S1-MME signaling and/or the S11 signaling) and the bearer termination point selection function are only implemented in one, or in both of the network elements for terminating a bearer to be set up (e.g. the eNB and the SGW in the example of FIGS. 1 and 2).

An implementation only to the eNB is capable of solving routing-related issues for the DL case, since then the DL traffic can use different destination addresses, i.e. different bearer termination points at the eNB. For the UL case, in order to be capable of solving routing-related issues by providing different transmission paths or routes for UL traffic, the eNB (and potentially also the backhaul network) may comprise a source based routing/forwarding function. Thereby, bearer traffic may be routed in accordance with source based routing on the basis of the selected termination point at the eNB. Otherwise, if also implemented to the SGW, no such source based routing function is required, as the UL traffic can similarly use a destination based routing/forwarding function on the basis of the selected termination point at the SGW.

Vice versa, an implementation only to the SGW is capable of solving routing-related issues for the UL case, since then the UL traffic can use different destination addresses, i.e. different bearer termination points at the SGW. For the DL case, in order to be capable of solving routing-related issues by providing different transmission paths or routes for DL traffic, the SGW (and potentially also the backhaul network) may comprise a source based routing function. Thereby, bearer traffic may be routed in accordance with source based routing on the basis of the selected termination point at the SGW. Otherwise, if also implemented to the eNB, no such source based routing function is required at the SGW, as the DL traffic can similarly use destination based forwarding on the basis of the selected termination point at the eNB.

According to exemplary embodiments of the present invention, very different cases of backhaul network types are applicable.

A system environment according to exemplary embodiments of the present invention may be applicable to L2 Ethernet access, where the transport is implemented as an Ethernet service or by native Ethernet.

In case of Ethernet access, an example application may be to configure the different termination points to have different IP subnets, and further to have a separate VLAN ID for each of the separate IP subnets. In the example of three bearer termination points in the eNB, as illustrated in FIG. 2, traffic from termination point Adr1 may use e.g. VLAN 101, traffic from termination point Adr2 may use e.g. VLAN 102, and traffic from termination point Adr3 may use e.g. VLAN 103.

Having the VLANs configured allows then building an Ethernet access network, where each VLAN can use a separate L2 path with VLAN-aware bridging (as defined by IEEE 802.1q). Alternatively to native IEEE 802.1 bridging, the Ethernet access can be realized as an Ethernet service by a service provider, where commonly VLAN ID is used to map the Ethernet frames into the intended Ethernet service. In the above example, three different services can be considered, where VLAN 101 may use Ethernet service 1, VLAN 102 may use Ethernet service 2, and VLAN 103 may use Ethernet service 3.

Accordingly, exemplary embodiments of the present invention can accomplish a routing of bearer traffic in accordance with a destination or source based routing function with a virtual local area network identifier assigned on the basis of the selected termination point.

A system environment according to exemplary embodiments of the present invention may be applicable to routed access, i.e. a routed access type backhaul network, where routes are configured statically or learned dynamically with a routing protocol.

In case of routed access, having different destination addresses for the different bearers implies having possibly separate routes for each of the destinations. So at each hop along the way, different next-hop may be defined for each of the destinations. Similarly, with source based routing, different next-hop may be defined for each of the sources (source addresses).

With static routes, a manual configuration of routes is required. With static routes, each route entry is manually entered, and thus for each destination a separate entry can be configured.

Routing protocols are commonly used to learn routes to remote destinations, and in this case route information is dynamically updated by the routing protocol. It may be wished to keep routing tables completely separate, for the different applications (transport bearers terminated on different termination points), as there may be cases where traffic, even though targeted for different destinations, would use the same node/link, even though it would be wished to use a different next hop, depending on the destination. In this case, different routing tables may be required in order to separate the routing information per termination point. This can be supported by the use of a virtual routing and forwarding (VRF) function, so that routing information can be kept specific to each “customer” or application (a customer being in this case the user plane bearers terminated to Adr1, another customer respectively the user plane bearers terminated to Adr2, and still another customer respectively the user plane bearers terminated to Adr3 for the eNB, and similarly for the SGW with respect to user plane bearers terminated to Adr11, Adr12 and Adr13).

Such approach is effective, as then the routes remain separate, and however the amount of VRFs equals the amount of different customers, i.e. different paths/routes (namely, three in the present example). Accordingly, the eNB and/or the SGW and/or the intermediate network nodes may comprise a virtual routing and forwarding function. Thereby, bearer traffic may be routed in accordance with virtual routing and forwarding on the basis of the selected termination points at the eNB and/or the SGW. With VRFs, the transmission paths/routes related to the bearers terminated to one termination point, are not visible or usable by the bearers terminated to other termination points.

A system environment according to exemplary embodiments of the present invention may be applicable to an MPLS network, i.e. a MPLS type backhaul network.

With MPLS, a forwarding equivalence class (FEC) defines a mapping of traffic to the MPLS label switch paths. The basic FEC is based on destination addresses. By virtue of the bearer termination point selection as outlined above, the use of MPLS is easier, as the FEC definition becomes less complex. Additionally, while the first MPLS router does not have the aforementioned information regarding bearer setup requirements, such information is available at the eNB and/or the SGW. Hence, there are more alternatives for allocating bearers to the MPLS LSPs with the bearer termination point selection as outlined above. With termination points selected by the eNB and/or the SGW on the basis of signaling, as outlined above, any external MPLS router may then use the termination point (IP address) information in the FEC definition. Thereby, bearer traffic may be routed in accordance with a multiprotocol label switching on the basis of the selected termination point at the eNB and/or the SGW by external MPLS routers. Optionally, also the eNB and/or the SGW may support multiprotocol label switching as an integrated function.

Additionally, with an MPLS network, the VRF functionality mentioned above can also be implemented at the eNB and/or the SGW and/or in MPLS routers.

As evident from the above, exemplary embodiments of the present invention may involve an investigation of signaling parameters, e.g. S1-AP and/or S11 signaling parameters originating from a mobility management part, for bearer setup requirements (which is effective, as these are also/already investigated for other purposes within the eNB and/or SGW), an availability of a number of candidate termination points for bearers, e.g. user plane bearers (i.e. multiple IP and/or L4 ports and/or GTP TEIDs), and an association between bearer setup requirements and bearer termination points for a selection thereof e.g. by a mapping table or the like. Also, exemplary embodiments of the present invention may involve optional functions and/or building blocks, e.g. support for VRFs, support for source based routing, support for destination based routing, support of assigning VLAN IDs, support of VLAN-aware switching, support for MPLS, and so on.

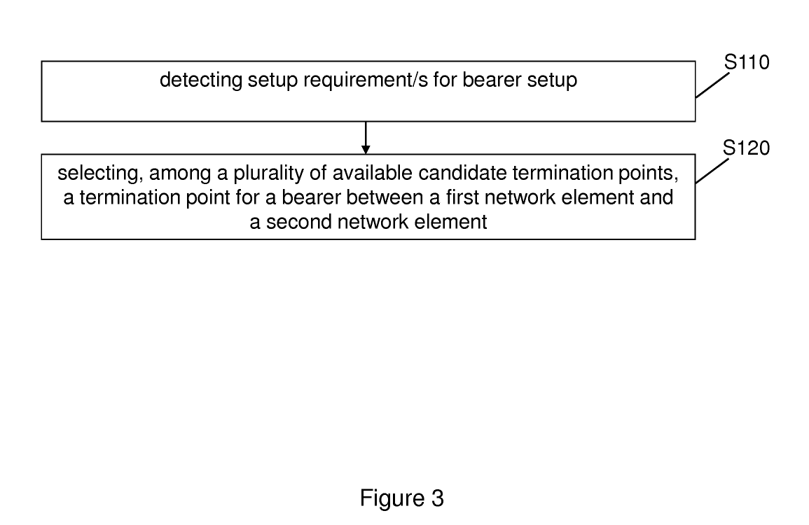

FIG. 3 shows a flowchart of a first example of a procedure according to exemplary embodiments of the present invention. As evident from the above, such procedure is operable at a first network element. Namely, irrespective of the kind of the second network element, it may be operable at a radio access network element such as the eNB according to FIGS. 1 and 2 and/or a core network element such as the SGW according to FIGS. 1 and 2.

As shown in FIG. 3, a procedure according to exemplary embodiments of the present invention comprises an operation (S110) of detecting at least one setup requirement for setup of a bearer, and an operation (S120) of selecting, among a plurality of available candidate termination points, a termination point for a bearer between the first network element and a second network element on the basis of the detected at least one setup requirement. According to exemplary embodiments of the present invention, the detecting operation may be for example be realized by the S1-MME signaling function at the eNB and/or the S11 signaling function at the SGW, and/or the selecting operation may be realized by the bearer termination point selection function at the eNB and/or the SGW.

Accordingly, exemplary embodiments of the present invention provide for an intelligent control of a bearer setup configuration in terms of an adaptive selection of at least one termination point of a bearer to be set up on the basis of the detected at least one setup requirement.

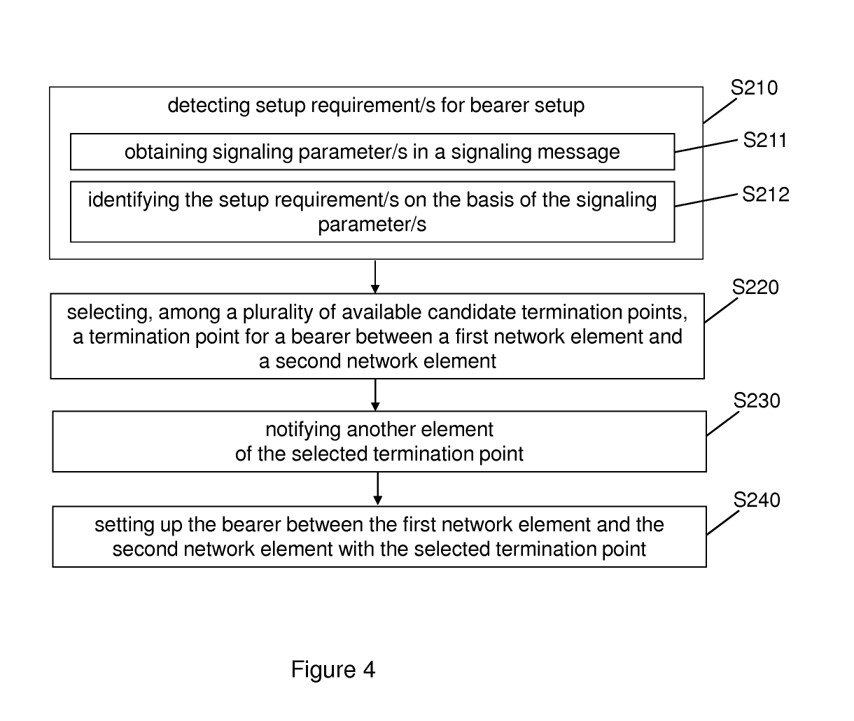

FIG. 4 shows a flowchart of a second example of a procedure according to exemplary embodiments of the present invention. As evident from the above, such procedure is operable at a first network element. Namely, irrespective of the kind of the second network element, it may be operable at a radio access network element such as the eNB according to FIGS. 1 and 2 and/or a core network element such as the SGW according to FIGS. 1 and 2.

It is noted that the detecting operation S210 according to FIG. 4 may be functionally equivalent to the detecting operation S110 according to FIG. 3, and/or the selecting operation S220 according to FIG. 4 may be functionally equivalent to the selecting operation S120 according to FIG. 3.

As shown in FIG. 4, the detecting operation S210 according to exemplary embodiments of the present invention may comprise an operation (S211) of obtaining at least one signaling parameter for the setup of the bearer in a signaling message (such as a message for instructing the setup or change of a bearer, or the like), and an operation (S212) of identifying the at least one setup requirement on the basis of the obtained at least one signaling parameter.

According to exemplary embodiments of the present invention, obtaining the signaling parameters may comprise receiving the signaling message from an appropriate element, i.e. another user plane element or a control plane element. Further, signaling messages and signaling parameters, which are applicable for exemplary embodiments of the present invention, are those mentioned above.

As shown in FIG. 4, irrespective of the realization of the detecting and selecting operations, a procedure according to exemplary embodiments of the present invention may additionally comprises an operation (S230) of notifying at least one of the other one of the first and second network element and a mobility management entity of the selected termination point, and an operation (S240) of setting up the bearer between the first network element and the second network element with the selected termination point. In the notification operation, referring to the system example of FIG. 2, the SGW and/or the MME may be notified by the eNB when the eNB performs the procedure, or the eNB and/or the MME may be notified by the SGW when the SGW performs the procedure. In the setup operation, the selected termination point may be specific for a route of the bearer between the first network element and the second network element.

As shown in FIG. 4, the notification operation S230 according to exemplary embodiments of the present invention is to notify another element of the selected termination point. The other element being notified may be at least one of the other one of the user plane elements (i.e. the first and second network elements) and a control plane element (such as a mobility management entity). That is, such notification may occur either directly between the user plane elements or via a control plane element. Upon bearer setup, the eNB may notify the MME of the selected termination point (IP address and GTP TEID) at the eNB, and/or the SGW may notify the MME of the selected termination point (IP address and GTP TEID at the SGW.

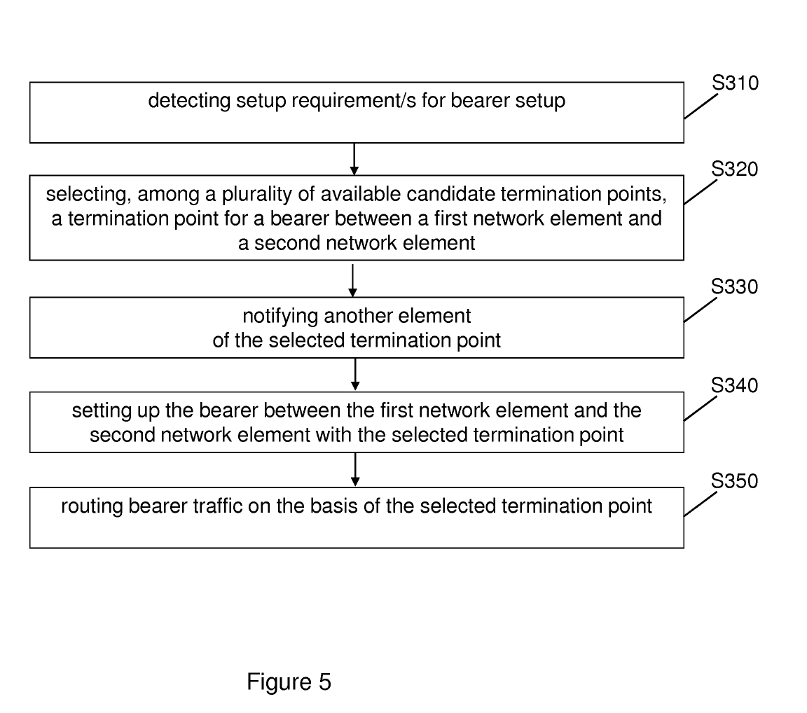

FIG. 5 shows a flowchart of a third example of a procedure according to exemplary embodiments of the present invention. As evident from the above, such procedure is operable at a first network element. Namely, irrespective of the kind of the second network element, it may be operable at a radio access network element such as the eNB according to FIGS. 1 and 2 and/or a core network element such as the SGW according to FIGS. 1 and 2.

It is noted that the detecting operation S310, the selecting operation S320, the notification operation S330 and the setup operation S340 according to FIG. 5 may be functionally equivalent to the detecting operation S210, the selecting operation S220, the notification operation S230 and the setup operation S240 according to FIG. 4, respectively.

As shown in FIG. 5, irrespective of the realization of the detecting, selecting, notification and setup operations, a procedure according to exemplary embodiments of the present invention may additionally comprises an operation (S350) of routing bearer traffic on the basis of the selected termination point. According to exemplary embodiments of the present invention, the routing operation S350 may comprise any one or more of the aforementioned routing approaches, including e.g. routing bearer traffic in accordance with a destination based routing function on the basis of the selected termination point, routing bearer traffic in accordance with a source based routing function on the basis of the selected termination point, routing bearer traffic in accordance with a destination or source based routing function with a virtual local area network identifier assigned on the basis of the selected termination point, routing bearer traffic in accordance with a virtual routing and forwarding function on the basis of the selected termination point, and routing bearer traffic in accordance with a forwarding equivalence class of a multiprotocol label switching function on the basis of the selected termination point.

In brief, according to exemplary embodiments of the present invention, there is provided an intelligent bearer setup configuration control, particularly an intelligent bearer setup configuration control capable of complying with various considerations for the routing of bearer traffic via separate transmission paths or routes.

In view of the above, exemplary embodiments of the present invention provide the capability of using multiple termination points for a bearer setup configuration of a bearer (such as e.g. a S1 bearer, a user plane bearer, or the like) by a control on the basis of one or more bearer setup requirements of a bearer (such as e.g. an E-RAB, a radio access bearer, or the like). Having different source/destination addresses allows traffic to be more easily directed to different transmission paths or routes, e.g. via a backhaul network. This is effective due to functionalities and characteristics of the different transmission paths or routes, which may be rather different and not necessarily (only) QoS related.

Accordingly, there is enabled the use of multiple termination points for a bearer setup configuration of a bearer for a single operator, e.g. for a single radio access network element and/or a core network element (of this operator). Further, enhanced or improved support for the backhaul or core network for mobile broadband, mobile Internet, or the like may be provided. Still further, traffic separation and/or differentiation and/or selection may be provided for the purpose of one or more of bearer setup, routing, load sharing/distribution, capacity expansion, and so on.

According to exemplary embodiments of the present invention, there is no need for special functionality in involved elements, such as e.g. DSCP-based routing or the use of MPLS traffic engineering. Yet, exemplary embodiments of the present invention are applicable to or with MPLS label switching by using the specific information usable for FEC definition, which is available at a radio access network element and/or a core network element (but not at an external router).

According to exemplary embodiments of the present invention, an implementation of corresponding functions and/or building blocks at a radio access network elements such as an eNB could be sufficient for solving (at least most significant) routing-related issues, without affecting the design or configuration of the backhaul or core network.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

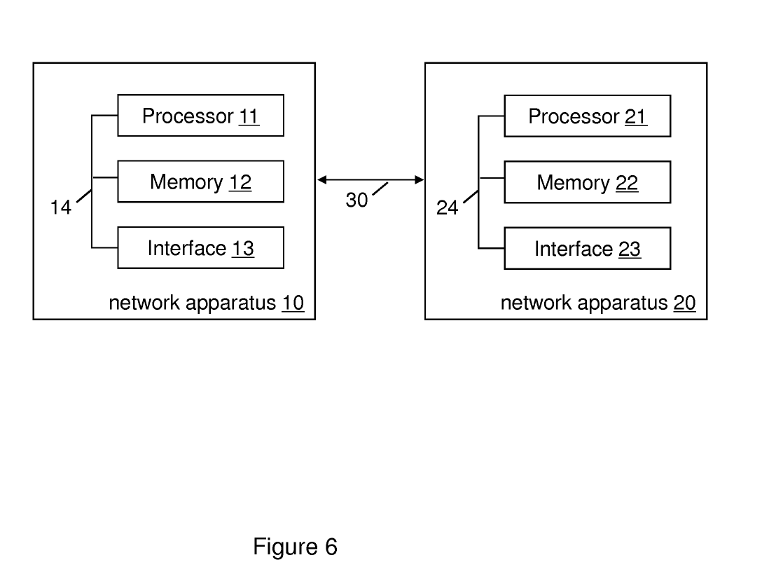

Respective exemplary embodiments of the present invention are described below referring to FIG. 6, while for the sake of brevity reference is made to the detailed description of respective corresponding configurations/setups, schemes, methods and functionality, principles and operations according to FIGS. 1 to 5.

In FIG. 6 below, the solid line blocks are basically configured to perform respective operations as described above. The entirety of solid line blocks are basically configured to perform the methods and operations as described above, respectively. With respect to FIG. 6, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 6, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 6 shows a schematic diagram of apparatuses according to exemplary embodiments of the present invention.

In view of the above, the thus illustrated apparatuses 10 and 20 are suitable for use in practicing the exemplary embodiments of the present invention, as described herein.

The thus illustrated apparatus 10 may represent a (part of a) network element according to exemplary embodiments of the present invention, and may be configured to perform a procedure and/or exhibit a functionality as described in any one of FIGS. 2 to 5. The thus illustrated apparatus 20 may represent a (part of a) network element according to exemplary embodiments of the present invention, and may be configured to perform a procedure and/or exhibit a functionality as described in any one of FIGS. 2 to 5.

For example, the apparatus 10 may relate to a radio access network, e.g. an eNB, and the apparatus 20 may relate to a core network element, e.g. a SGW, as exemplified in the system environment according to FIGS. 1 and 2, upon which the above description in exemplarily based for the illustrative purposes only. Similarly, the apparatus 10 may relate to a radio access network, e.g. an eNB, and the apparatus 20 may relate to a radio access network element, e.g. another eNB, or the apparatus 10 may relate to a core network, e.g. a SGW, and the apparatus 20 may relate to a core network element, e.g. another SGW.

Accordingly, exemplary embodiments of the present invention could be applicable between at least one radio access network (element) and at least one core network (element), between at least two radio access networks (radio access elements), or between at least two core networks (core network elements). While the operability according to exemplary embodiments of the present invention could be guided/supported by control plane (e.g. MME) signaling, it could equally be guided/supported by corresponding other signaling, e.g. any signaling to a radio network element or a core network element, which comprises equivalent contents from which at least one signaling parameter for the setup of a bearer could be obtained.

As evident from the above, exemplary embodiments of the present invention are applicable to various system environments, such as the following.

1. The apparatuses 10 and 20 represent two radio access network elements, and a signaling (usable for detecting at least one setup requirement for setup of a bearer) is (directly) between these two network elements. An example in a LTE/LTE-A system could be an implementation between two eNBs, with a X2 signaling there-between. An example in a 3G system could be an implementation between a Node B and a RNC, over the Iub interface, with a NBAP signaling there-between. Another example in a 3G system could be an implementation between two RNCs, over the Iur interface, with a RNSAP signaling there-between.

2. The apparatuses 10 and 20 represent a radio access network element and a core network element, and a signaling (usable for detecting at least one setup requirement for setup of a bearer) is (directly) between these two network elements. An example in a 3G system could be an implementation between a RNC and a SGSN, over the Iu interface, with a RANAP signaling there-between.

3. The apparatuses 10 and 20 represent a radio access network element and a core network element, and a signaling (usable for detecting at least one setup requirement for setup of a bearer) is over a separate (control plane) element between these two network elements. An example in a LTE/LTE-A system could be an implementation between an eNB and a SGW, with an MME being responsible for the signaling there-between (via a S1 interface and a S11 interface).

4. The apparatuses 10 and 20 represent two core network elements, and a signaling (usable for detecting at least one setup requirement for setup of a bearer) is (directly) between these two network elements. An example in a LTE/LTE-A system could be an implementation between a SGW and a PGW over a S5/S8 interface there-between.

As indicated in FIG. 6, according to exemplary embodiments of the present invention, each of the apparatuses 10/20 comprises a processor 11/21, a memory 12/22 and an interface 13/23, which are connected by a bus 14/24 or the like. The apparatuses 10 and 20 may be connected via a link or connection 30 (possibly via some element or entity being located between the apparatuses 10 and 20).

The processor 11/21 and/or the interface 13/23 may also include a modem or the like to facilitate communication over a (hardwire or wireless) link, respectively. The interface 13/23 may include a suitable transceiver coupled to one or more antennas or communication means for (hardwire or wireless) communications with the linked or connected device(s), respectively. The interface 13/23 is generally configured to communicate with at least one other apparatus, i.e. the connector thereof.

The memory 12/22 may store respective programs assumed to include program instructions or computer program code that, when executed by the respective processor, enables the respective electronic device or apparatus to operate in accordance with the exemplary embodiments of the present invention. For example, the memory 12/22 may store the detected setup requirements and/or obtained signaling parameters and/or received signaling messages, as well as means or measure associating bearer setup requirements with different bearer termination points out of the (locally) available candidate termination points, e.g. a configuration or mapping table, an algorithm or function, or the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “processor configured to [cause the apparatus to] perform xxx-ing” is construed to be equivalent to an expression such as “means for xxx-ing”).

In its most basic form, according to exemplary embodiments of the present invention, the apparatus 10 or its processor 11 may be configured to perform detecting at least one setup requirement for setup of a bearer, and selecting, among a plurality of available candidate termination points, a termination point for a bearer between a radio access network element and a core network element on the basis of the detected at least one setup requirement.

Additionally or alternatively, in its most basic form, according to exemplary embodiments of the present invention, the apparatus 20 or its processor 21 may be configured to perform detecting at least one setup requirement for setup of a bearer, and selecting, among a plurality of available candidate termination points, a termination point for a bearer between a radio access network element and a core network element on the basis of the detected at least one setup requirement.

Accordingly, stated in other words, the apparatus 10 and/or the apparatus 20 at least comprises respective means for detecting at least one setup requirement for setup of a bearer, and means for selecting, among a plurality of available candidate termination points, a termination point for a bearer between a radio access network element and a core network element on the basis of the detected at least one setup requirement.

According to exemplary embodiments of the present invention, the structural and/or functional arrangement of the apparatuses 10 and 20 may be equivalent or different.

For further details regarding the operability/functionality of the individual apparatuses, reference is made to the above description in connection with any one of FIGS. 2 to 5, respectively.

According to exemplarily embodiments of the present invention, the processor 11/21, the memory 12/22 and the connector 13/23 may be implemented as individual modules, chips, chipsets, circuitries or the like, or one or more of them can be implemented as a common module, chip, chipset, circuitry or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for intelligent bearer setup configuration control. Such measures exemplarily comprise detection of at least one setup requirement for setup of a bearer, and selection of a termination point for a bearer between a first network element and a second network element among a plurality of available candidate termination points on the basis of the detected at least one setup requirement. For example in a LTE/LTE-A system environment, the setup configuration of a S1 bearer between eNB and SGW can be controlled on the basis of setup requirements for an E-RAB, involving MME as a control plane element (via S1-MME and S11 signaling).

The measures according to exemplary embodiments of the present invention may be applied for any kind of network environment, such as for example for fixed and/or mobile communication systems e.g. in accordance with any related standard. For example, exemplary embodiments of the present invention may be applicable in 3G standards and/or UMTS standards and/or HSPA standards and/or LTE standards (including LTE-Advanced and its evolutions) and/or WCDMA standards.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3G 3^{rd} Generation (system)

### 3GPP 3rd Generation Partnership Project

### AMBR Aggregate Maximum Bit Rate

### APN Access Point Name

### ARP Allocation and Retention Priority

### AP Application Protocol

### CSG Closed Subscriber Group

### DL Downlink

### DSCP Differentiated Services Code Point

eNB evolved Node B (E-UTRAN base station)

### EPC Evolved Packet Core

### EPS Evolved Packet Service

### E-RAB E-UTRAN Radio Access Bearer

### E-UTRAN Evolved UTRAN

### FEC Forwarding Equivalence Class

### F-TEID Fully Qualified Tunnel Endpoint Identifier

### GBR Guaranteed Bit Rate

### GFP Generic Framing Procedure

### GPRS General Packet Radio Service

### GTP GPRS Tunneling Protocol

### GTP-U GPRS Tunneling Protocol User Plane

### HLR Home Location Register

### HSPA High Speed Packet Access

### ID Identifier

### IETF Internet Engineering Task Force

### IP Internet Protocol (IPv4 or IPv6)

### LTE Long Term Evolution

### LTE-A Long Term Evolution Advanced

### MBR Maximum Bit Rate

### MME Mobility Management Entity

### MPLS Multiprotocol Label Switching

### NBAP Node B Application Part

### NE Network Element

### PCEF Policy and Charging Enforcement Function

### PCRF Policy and Charging Rules Function

### PDN Packet Data Network

### PGW PDN Gateway

### PPP Point-to-Point Protocol

### QCI QoS Class Identifier

### QoS Quality of Service

### RFC Request for Comments

### RANAP Radio Access Network Application Part

### RAT Radio Access Technology

### RNC Radio Network Controller

### RNSAP Radio Network Subsystem Application Part

### S1AP S1 Application Protocol

### SCTP Stream Control Transmission Protocol

### SDH Synchronous Digital Hierarchy

### SEG Security Gateway

### SGSN Serving GPRS Support Node

### SGW Serving Gateway

### TDM Time Division Multiplex

### TCP Transmission Control Protocol

### TS Technical Specification

### TEID Tunnel Endpoint Identifier

### UDP User Datagram Protocol

### UE User Equipment

### UL Uplink

### UMTS Universal Mobile Telecommunications System

### UTRAN UMTS Terrestrial Radio Access Network

### VLAN Virtual Local Area Network

### VRF Virtual Routing and Forwarding

X2AP X2 Application Protocol

1.-20. (canceled)

21. A method comprising
detecting at least one setup requirement for setup of a bearer, and
selecting, among a plurality of available candidate termination points, a termination point for a bearer between a first network element and a second network element on the basis of the detected at least one setup requirement.

22. The method according to claim 21, wherein the detecting comprises
obtaining at least one signaling parameter for the setup of the bearer in a signaling message, and
identifying the at least one setup requirement on the basis of the obtained at least one signaling parameter.

23. The method according to claim 22, wherein
the method is operable at or by a radio access network element, wherein the bearer is to be set up between the radio access network element and another radio access network element or a core network element, and the obtaining comprises receiving the signaling message from one of a mobility management entity, the other radio access network element and the core network element, and/or
the method is operable at or by a core network element, wherein the bearer is to be set up between the core network element and a radio access network element or another core network element, and the obtaining comprises receiving the signaling message from one of a mobility management entity, the other core network element and the radio access network element.

24. The method according to claim 22, wherein
the signaling message comprises bearer setup related message issued by a control plane element or a user plane element, and/or
the at least one signaling parameter relates to the setup or change of at least one of a radio access bearer and a packet service bearer, and/or
the at least one signaling parameter corresponds to at least one quality-of-service related parameter, and/or
the at least one signaling parameter corresponds to at least one subscriber profile related parameter.

25. The method according to claim 21, further comprising
notifying at least one of the other one of the first and second network element and a mobility management entity of the selected termination point, and
setting up the bearer between the first network element and the second network element with the selected termination point.

26. The method according to claim 25, wherein
the method is operable at or by one of a radio access network element and a core network element, wherein the bearer is to be set up between the radio access network element and another radio access network element or the core network element, or between the core network element and another core network element or the radio access network element, and
at least one of the other one of the radio access network element and the core network element and the mobility management entity is notified of the selected termination point.

27. The method according to claim 26, wherein
the set up bearer comprises a user plane bearer, and/or
the set up bearer comprises a S1 bearer between a base station representing the radio access network element and a serving gateway representing the core network element, and/or
the selected termination point comprises at least one a transport layer address and a tunnel endpoint identifier, and/or
the selected termination point is specific for a route of the bearer between the radio access network element and the core network element.

28. The method according to claim 27, wherein the transport layer address comprises an IP address and/or represents a physical interface or a virtual local area network interface or a loopback address.

29. The method according to claim 21, further comprising at least one of
routing bearer traffic in accordance with a destination based routing function on the basis of the selected termination point,
routing bearer traffic in accordance with a source based routing function on the basis of the selected termination point,
routing bearer traffic in accordance with a destination or source based routing function with a virtual local area network identifier assigned on the basis of the selected termination point,
routing bearer traffic in accordance with a virtual routing and forwarding function on the basis of the selected termination point, and
routing bearer traffic in accordance with a forwarding equivalence class of a multiprotocol label switching function on the basis of the selected termination point.

30. An apparatus comprising
an interface configured to connect to at least another apparatus,
a memory configured to store computer program code, and
a processor configured to cause the apparatus to perform:
detecting at least one setup requirement for setup of a bearer, and
selecting, among a plurality of available candidate termination points, a termination point for a bearer between a first network element and a second network element on the basis of the detected at least one setup requirement.

31. The apparatus according to claim 30, wherein the processor is configured to cause the apparatus to perform the detecting by:
obtaining at least one signaling parameter for the setup of the bearer in a signaling message, and
identifying the at least one setup requirement on the basis of the obtained at least one signaling parameter.

32. The apparatus according to claim 31, wherein
the apparatus is operable as or at a radio access network element, wherein the bearer is to be set up between the radio access network element and another radio access network element or a core network element, and the processor is configured to cause the apparatus to perform the obtaining by receiving the signaling message from one of a mobility management entity, the other radio access network element and the core network element, and/or
the apparatus is operable as or at a core network element, wherein the bearer is to be set up between the core network element and a radio access network element or another core network element, and the processor is configured to cause the apparatus to perform the obtaining by receiving the signaling message from one of a mobility management entity, the radio access network element and the other core network element.

33. The apparatus according to claim 31, wherein
the signaling message comprises a message issued by a control plane element or a user plane element, and/or
the at least one signaling parameter relates to the setup or change of at least one of a radio access bearer and a packet service bearer, and/or
the at least one signaling parameter corresponds to at least one quality-of-service related parameter, and/or
the at least one signaling parameter corresponds to at least one subscriber profile related parameter.

34. The apparatus according to claim 30, wherein the processor is configured to cause the apparatus to perform:
notifying at least one of the other one of the first and second network element and a mobility management entity of the selected termination point, and
setting up the bearer between the first network element and the second network element with the selected termination point.

35. The apparatus according to claim 34, wherein
the apparatus is operable as or at one of a radio access network element and a core network element, wherein the bearer is to be set up between the radio access network element and another radio access network element or the core network element, or between the core network element and another core network element or the radio access network element, and
the processor is configured to notify at least one of the other one of the radio access network element and the core network element and a mobility management entity of the selected termination point.

36. The apparatus according to claim 35, wherein
the set up bearer comprises a user plane bearer, and/or
the set up bearer comprises a S1 bearer between a base station representing the radio access network element and a serving gateway representing the core network element, and/or
the selected termination point comprises at least one of a transport layer address and a tunnel endpoint identifier, and/or
the selected termination point is specific for a route of the bearer between the radio access network element and the core network element.

37. The apparatus according to claim 36, wherein the transport layer address comprises an IP address and/or represents a physical interface or a virtual local area network interface or a loopback address.

38. The apparatus according to claim 30, wherein the processor is configured to cause the apparatus to perform at least one of:
routing bearer traffic in accordance with a destination based routing function on the basis of the selected termination point,
routing bearer traffic in accordance with a source based routing function on the basis of the selected termination point,
routing bearer traffic in accordance with a destination or source based routing function with a virtual local area network identifier assigned on the basis of the selected termination point,
routing bearer traffic in accordance with a virtual routing and forwarding function on the basis of the selected termination point, and
routing bearer traffic in accordance with a forwarding equivalence class of a multiprotocol label switching function on the basis of the selected termination point.

39. A computer program product embodied on a non-transitory computer-readable medium, said product comprising computer-executable computer program code which, when the program is run on a computer, is configured to cause the computer to carry out the method according to claim 21.
